(19) United States
(12) Patent Application Publication
(10) Pub. No.: US 2007/0198382 A1
(43) Pub. Date: Aug. 23, 2007

(54) METHOD OF SAVING FOR A TIME DELAYED PURCHASE

(76) Inventor: Michael R. FERRARI, Des Moines, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/675,444

(22) Filed: Feb. 15, 2007

Related U.S. Application Data
(60) Provisional application No. 60/766,913, filed on Feb. 17, 2006.

(51) Int. Cl. G06Q 40/00

(52) U.S. Cl. 705/35

(57) ABSTRACT

A method of saving for a time delayed purchase includes establishing a savings account through a website provided by a third party service provider. The savings account establishes the savings goal, the time frame, the recommended contribution, and the savings category and/or category of retailer(s). Once established, a customer designates the account as public or private. For a private account, funds are transferred from the customer's financial institution based upon approved parameters. For a public account, a notification is sent to potential third party contributors who make a gift to the public account that is held by the service provider. The customer is given the option of accepting the gift, whereby funds are transferred from the service provider to the public account.

### CROSS REFERENCE TO RELATED APPLICATION

This application claims the benefit of U.S. Provisional Application Ser. No. 60/766,913 filed Feb. 17, 2006.

### BACKGROUND OF THE INVENTION

This invention is directed to a method of savings for a time delayed purchase, and more specifically a method of saving utilizing an electronic network.

In years past financial institutions offered savings programs specifically designed for a specific purpose such as a vacation. Periodically a customer would deposit funds in this account until the savings goal was met. These types of savings programs were particularly helpful in teaching children the value of savings. Over the years, these types of programs, in light of technical advances and other factors, were discontinued.

Now, through advantages provided by the Internet, the charm and value of these purchase defined savings accounts can be recreated with added features and benefits that educate customers and children on the value of saving for items they desire to purchase.

An object of the invention is to provide a method of saving for a desired purchase that is easy to establish and maintain.

A further object is to provide a method of savings for a desired purchase that provides educational information and/or financial incentives.

These and other objects will be apparent to one skilled in the art based on the following written description.

### SUMMARY OF THE INVENTION

A method of saving for a time delayed purchase includes establishing a savings account through a website provided by a third party service provider. The savings account establishes the savings goal, the time frame, the recommended contribution, and the savings category and/or category of retailer(s). Once established, a customer designates the account as public or private. For a private account, funds are transferred from the customer's financial institution based upon approved parameters. For a public account, a notification is sent to potential third party contributors who make a gift to the public account that is held by the service provider. The customer is given the option of accepting the gift, whereby funds are transferred from the service provider to the public account.

Once the savings goal is reached, the service provider sends the customer a payment document. The payment document is used to redeem goods and services from a sponsor or a retailer. Once redeemed, the sponsor or retailer pay the service provider a transaction fee.

With customer consent, customer information is provided to sponsors for marketing purposes. Periodic e-mails are sent to customers advising them of promotions, and educating customers on financial matters. Upon reaching customer's saving's goal, sponsor coupons are provided along with payment document to encourage a purchase at the sponsor's place of business.

### BRIEF DESCRIPTION OF THE DRAWINGS

FIG. 1 is a schematic view of the environment of a savings method;

FIG. 2 is a flow diagram of a savings method; and

FIG. 3 is a plan view of a website screen shot.

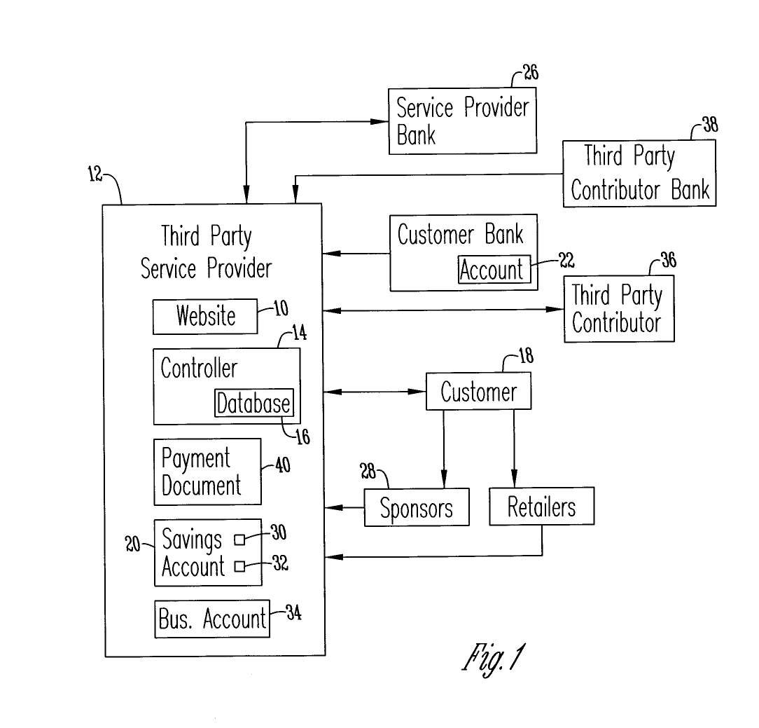

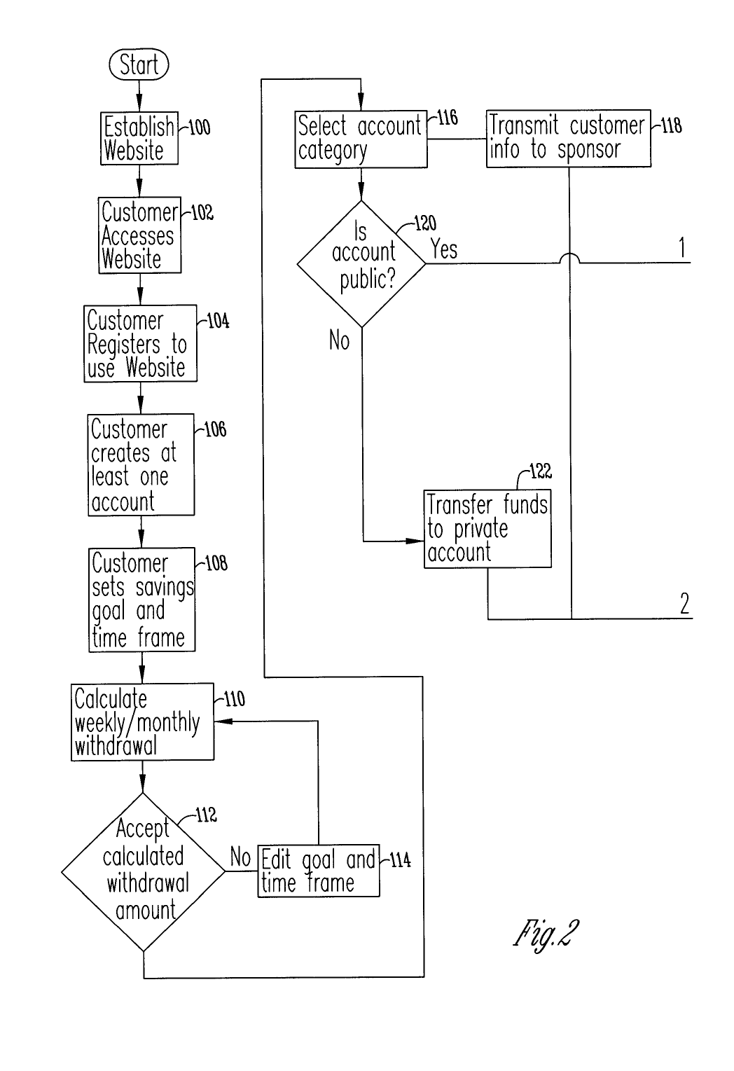

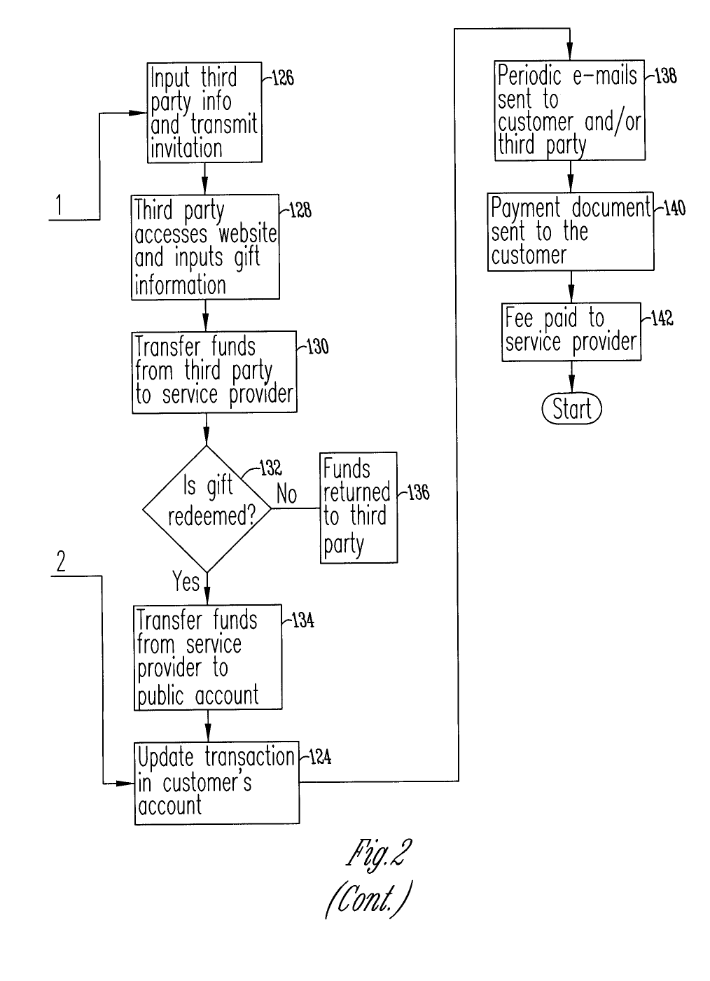

### DETAILED DESCRIPTION OF THE PREFERRED EMBODIMENTS

The method provides a means not only to educate, but also provides an easy means to coordinate the efforts of a number of entities toward the goal of saving for or funding a desired purchase. The method begins at step 100 by establishing a website 10 that is provided by a third party service provider over a third party network. Connected to the website 10 is a controller/processor 14 having a secured database 16. Once the website is established, a customer 18 accesses the website 10 through the electronic network at step 102 and registers as a user at step 104 by providing various personal information. As an example, the customer 18 would input information including but not limited to, their name, address, birth date, social security number, bank name, bank phone number, bank routing and account number, bank account type, a log in user name, and a password. This information is stored in the secured database 16 by the service provider 12.

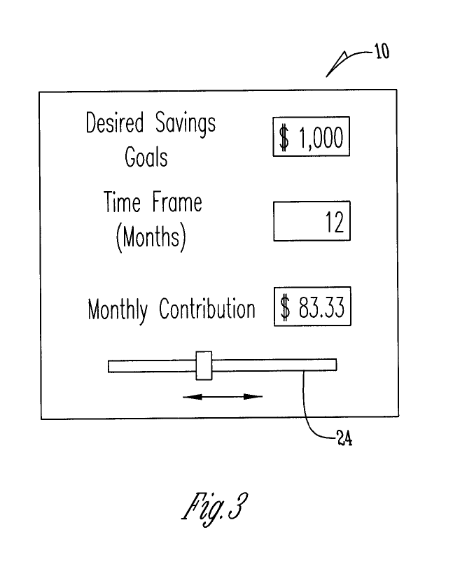

Once registered, the customer 18 creates one or more savings accounts 20 based on a desired purchase at step 106. To begin, the customer names the savings account, sets a desired savings goal, and determines a time frame for reaching the savings goal at step 108. Through the controller 14 that is in electronic communication with the website 10, the processor 14 automatically calculates the weekly and/or monthly contribution needed and transmits this information to the customer 18 at step 112. The customer 18 may either accept the calculated amount at step 112 which will automatically be withdrawn from their checking account 22, or at step 114 the customer 18 may edit the savings goal or savings time period until an acceptable withdrawal amount is calculated. Preferably, the website 10 has a sliding scale calculator 24 as shown in FIG. 3 that permits the customer 18 to click on the scale 24 and move the cursor in either direction to change the withdrawal amount which adjusts the time frame accordingly. Also, the calculated withdrawal amount includes interest earned in the account 20 over the calculated time frame. Once the customer 18 has edited the withdrawal amount, steps 110 and 112 are repeated until the amount is accepted.

The created savings account 20 is hosted by the service provider 12 at the service provider's financial institution 26. The customer 18 follows required verification rules such as providing a signature, setting up on-line security, providing confirmation of establishing and authorizing the account, and the like.

In establishing the savings account 30, a customer 18 selects a product or service category at step 116. For example, a customer 18 may establish an account 20 for a vacation, wedding, television, Christmas, car, wedding ring, computer, motorcycle, memorial for a funeral, or the like. The categories may be defined more broadly and include, but are not limited to, electronics, travel, home improvement, automobiles, weddings, and gifts. Based on the category the customer 18 is able to take advantage of discounts provided by sponsors 28 who are partnering with the service provider 12.

With customer consent, the service provider 12 transmits customer information to the sponsor 28 at step 118. This information is used by the sponsor to identify common characteristics of consumers selecting categories of products or services the sponsor 28 provides to assist the sponsor 28 in future marketing efforts.

In one embodiment, the customer 18 determines if the savings account 20 will be public 30 or private 32 at step 120. A private savings account 32 is private to that customer 18 and will be funded solely by the customer 18. The customer 18 funds the savings account 20 through a credit card, ACH transfer such as an auto bill pay or e-wallet, or an internal transfer at step 122. Processing fees may be included. Should the customer 18 select a credit card a processing fee is charged by the service provider 12 and the transaction is given a reference number indicating which savings account 20 funds are disbursed to from the service providers business account 34. An auto bill pay is handled in the same manner as an e-check/ACH transfer where the customer 18 inputs a routing number and the account number to create an auto deduction and deposit into the service providers business account 34. An e-wallet transaction is handled in the same manner except that the cost of the transaction is billed directly to the customer 18. An internal transfer occurs where the customer has an account at the service provider's financial institution 26 and a transfer is made from the customer's account to the service providers account 34. Upon redemption/transfer, authorized funds are transferred from the service provider's account 34 to the savings account 20. Once the funds are transferred the customer's account 20 is updated and the customer 18, through the website, is able to view a detailed transaction history of transactions, as well as pending transactions.

A public account 30 permits a customer 18 to accept electronic gifts from third parties 36. These gifts may be a one time contribution or may be set up for multiple contributions over a period of time. Also, some savings accounts 20, such as for a wedding or memorial for a funeral may be solely funded by third party contributions. To set up a public account 30 the customer 18 at step 126 inputs contact information such as an e-mail or mailing address of third parties (i.e., friends and family) who are sent either electronically or through the mail an invitation that describes the customer's saving initiatives and asks whether the third party wishes to purchase a gift savings. To make a gift, the third party contributor 36 accesses the website 10 through an electronic network and inputs information regarding the savings account 20, the amount of the gift, the method of payment, and personal information, including the third party's banking information at step 128. The third party 36 has the option of paying by credit card, e-check, or through an electronic wallet. If the third party 36 pays with a credit card, they will input all necessary information for making an online transaction. A processing fee is charged to the third party 36. The transaction will have a reference number from which the service provider 12 will use to distribute funds to a savings account 20 upon approval. Processing fees may be included. If a third party 36 selects an e-check, the transaction will follow the same procedures with a nominal fee charged. If the third party 36 selects their electronic wallet, the process is the same as that of the e-check. Once the third party 36 has inputted gift information and selected a method of payment, funds are transferred from the third party's financial institution 38 to the service provider's business account 34 at step 130.

Once funds have cleared on the above transaction, the customer 18 receives a message notifying them of the gift and asking if they would like to redeem the gift at step 132. The notification is made either upon logging in to the customer's account, or through an e-mail prompt. Upon redemption, authorized funds are transferred from the service provider's business account 34 to the public account 30 at step 134. As with the private account 32, the customer's account is updated and the customer 18 has the ability to view a detailed transaction history of transactions and pending transactions at step 124. If the customer 18 does not accept the gift, the funds are returned to the third party contributor 36 at step 136.

Periodically at step 138, e-mails are sent to the customer 18 and/or third party contributor 36, providing updates on savings account activity, financial advice and information such as savings tips and the like, and discounts from sponsors 28 who have partnered with the service provider. The discounts may be directly related to the product or service category of the savings account 20 or are promotions for unrelated products encouraging the customer 18 to create a new savings account.

Once the savings goal has been met at step 140 the service provider 12 sends a payment document 40 to the customer 18 that allows them to make the desired purchase. The payment document 40 includes the saved amount along with any interest earned. The document may be of many types such as a check or an amount limited gift, debit, or credit card. Included with the payment document 40 is a coupon or discount document 42 supplied by the sponsor 28. The discount document is supplied to encourage the customer 18 to make the purchase as the sponsor's 28 place of business. Regardless of where the customer 18 makes the purchase, either the sponsor or the retailer pays the service provider 12 a fee based on the transaction at step 142. In a preferred embodiment the service provider would receive 50% of the sponsor discount, and between 1-3% of the total transaction for any purchase.

A method for savings for a time delayed purchase has been disclosed that, at the very least, meets all the stated objective.

What is claimed:

1. A method of savings for a time delayed purchase, comprising the steps of:
creating a savings account for a customer through a website connected to an electronic network and provided by a third party service provider;
inputting a desired savings goal and desired time frame;
calculating a recommended savings contribution;
designating the savings account as either private or public;
transferring funds to the savings account;
providing a payment document to the customer when the desired savings goal is met.

2. The method of claim 1 further comprising the step of inputting information related to third party contributors.

3. The method of claim 1 wherein a gift is transferred from a third party contributor to the service provider and the customer is given the option of accepting the gift.

4. The method of claim 3 wherein funds are transferred from the service provider to the savings account once the customer accepts the gift.

5. The method of claim 1 further comprising the step of transferring customer information to a sponsor.

6. The method of claim 1 further comprising the step of providing a discount coupon from a sponsor.

7. The method of claim 1 further comprising the step of editing the calculated recommended savings contribution.

8. The method of claim 7 wherein the calculated recommended savings contribution is edited with a sliding scale on the website.

9. The method of claim 1 further comprising the step of presenting the payment document to a retailer to make the desired purchase.

10. The method of claim 9 wherein the retailer pays a transaction fee to the service provider.
